(19) United States
(12) Patent Application Publication
(10) Pub. No.: US 2005/0143496 A1
(43) Pub. Date: Jun. 30, 2005

(54) Adhesives for car body assembly

(76) Inventor: Mathias Mueller, Weisenheim a.S. (DE)

Correspondence Address: HENKEL CORPORATION, THE TRIAD, SUITE 200, 2200 RENAISSANCE BLVD., GULPH MILLS, PA, 19406, US

(21) Appl. No.: 10/999,879

(22) Filed: Nov. 30, 2004

(30) Foreign Application Priority Data
Dec. 9, 2003 (DE) 103 57 355.0

(51) Int. Cl. C08L 63/00

(52) U.S. Cl. 523/400; 156/330

(57) ABSTRACT

Two-component epoxide resin compositions are described in which the epoxy component A contains at least one epoxide resin with an epoxy functionality greater than 1 and as second component B there is used a liquid or pasty hardener component containing amines, polyetheramines, polyaminoamides, Mannich bases and/or compounds containing mercapto groups, which additionally contains a non-volatile and non-corrosive accelerator. These adhesives can be used in automobile carcass assembly as well as in general automobile construction, whereby a rapid handling time is achieved and warping in structural parts is avoided.

### CROSS-REFERENCE TO RELATED APPLICATION

This application claims priority under 35 U.S.C. Section 119 to German Application DE 10357355.0, filed 9 Dec. 2003, incorporated herein by reference in its entirety.

### FIELD OF THE INVENTION

The present invention relates to epoxy compositions which can be used as an adhesive in automobile construction. The present invention further relates to a method for bonding automobile structural parts.

### DISCUSSION OF THE RELATED ART

In automobile construction structural parts, especially metallic structural parts, are increasingly being joined by adhesive bonding. In car body carcass construction it is preferable for this purpose to apply one-component adhesives to the structural parts; subsequently these structural parts are joined. The car body carcass constructed in this way subsequently passes through a series of process baths such as dipping or spraying processes for degreasing, phosphating and cathodic electrodeposition coating (CEC). Not until after cathodic electrodeposition coating, in the case of the customary processes to date, is a thermosetting one-component adhesive cured thermally in the “CEC oven”; for this purpose, with the customary processes, approximately 30 minutes at temperatures of approximately 180° C. are available. It emerges from this production sequence that the adhesive, during passage through the aqueous treatment processes, is not yet hardened. Since the aqueous media act on the car body parts in some cases at considerable pressure—whether it be the spraying pressure of application or the accumulation pressure of the treatment bath—there is a risk that an uncured adhesive will be washed out wholly or partly and will therefore be unable to fulfill its function. Additionally this washed-out adhesive can lead to contamination of the pretreatment baths and may result in considerable paint defects in the further painting process.

In order to eliminate wash-out problems of this kind the adhesive has to date been prehardened or pregelled. This is done either by inductive heating of the joined structural parts or by the passing of the car body or of the structural parts through a special “carcass assembly oven” at approximately +120° C. for approximately 12 minutes.

Particularly in the case of the hybrid mode of construction from different materials (different metals, e.g., steel sheet structural parts and aluminum structural parts or else fiber-reinforced plastics such as SMC structural parts) this thermal prehardening or pregelling is accompanied by warping of structural parts and distortions due to the different expansion of the materials. The heating-up of the structural parts in the case of induction heating, this heating-up being only local, leads to warping of structural parts with particular frequency. It is also necessary to install induction units, which are susceptible to faults. The installation of a carcass assembly oven also signifies considerable demand for energy, space and capital investment.

Not only for bonds of structural parts in subsequent manufacturing steps of the car body construction, such as in final assembly, for example, the so-called “trim shop”, after the painting steps, but also, in particular, in connection with the repair of vehicles, however, there is no sufficiently high process temperature available for fully curing adhesives which are thermosetting as one-component systems. The two-component adhesives known to date which are fully curable at room temperature have a number of drawbacks. When used on oiled metal sheet parts they generally exhibit completely inadequate adhesion and aging on the oiled metal sheets used in automobile construction. Furthermore, the cure rate at room temperature is unsatisfactorily long. To solve this problem the proposals to date have involved either heating times and temperatures which are comparable to the hardening conditions of systems which are thermosetting as one-component systems. Alternatively, hardeners and/or accelerators are proposed which are either objectionable from the standpoint of occupational hygiene, such as highly reactive aliphatic diamines of low molecular mass, for example, or contain corrosive constituents, such as Lewis acids (e.g., complexed boron halides). A further drawback of highly accelerated two-component epoxide systems of this kind is their very limited pot life, i.e., the time available between mixing of the two components and the latest point in time at which the structural elements may be joined.

High-strength epoxy structural adhesives known to date for automobile carcass assembly, possessing good adhesion to oiled substrates, have therefore been exclusively thermosetting systems, which generally necessitate a pregelling step. Thus, EP 101964 A describes a pasty, thermosetting epoxy adhesive which has been modified using vinyl acetate polymers or copolymers and so can be pregelled at relatively low temperatures, in order to ensure sufficient resistance to being washed out by the aforementioned aqueous process liquids.

Similarly EP 558798 describes an epoxide resin composition comprising epoxide resins, heat-activable hardeners and a polymer powder based on an aromatic thermoplastic polymer having a glass transition temperature of 120° C. or more which is present as a separate phase in the adhesive composition. Although epoxide resin compositions of this kind containing thermoplastic polymers can be pregelled at a relatively low temperature, an additional heat source is needed in the manufacturing line in order to help accomplish this pregelling.

WO 92/18575 proposes a hybrid binder system comprising a mixture of an acrylate and epoxide binder in combination with a tri- or tetrafunctional ketimine as hardening agent. This adhesive composition permits a two-stage cure in which, in a first stage, the adhesive is moisture-curing in order to attain an initial strength. In a second stage the intention is that the adhesive is then cured to the final strength at elevated temperatures. Although the moisture curing does not require any additional heat source in the carcass assembly area, this system has the drawback of the very slow moisture curing, particularly in the case of the non-porous and non-moisture-permeable substrates that are customary in carcass assembly, so that a serviceable initial strength is obtained only after some hours or days of moisture exposure.

WO 96/11240 likewise describes a structural adhesive having a dual hardening mechanism. This publication proposes using a combination of an isocyanate-containing hardener with a component which contains hydroxyl groups, these components initially reacting at room temperature to form a pressure-sensitive adhesive which then cures at temperatures of at least 100° C. as a structural adhesive. Details concerning the adhesion properties on oil-containing substrates are not given in this publication.

EP 1186642 A1 describes two-component compositions for the underlaying, edge-raised seam bonding and sealing of car body sections, especially for the edge-raised seam sealing of externally mounted components on vehicles. It is indicated that within the predetermined cycle times the two-component systems achieve the handling strength which is necessary for mounting the externally mounted components onto the car body, and achieve the necessary strength and dimensional stability for the manufacturing process and for passage through the CEC bath by virtue of two-fold crosslinking. This publication proposes using a UV-induced reaction for initial crosslinking until a state of transportability is reached. A drawback with a photochemically initiated initial crosslinking of this kind is that areas of adhesive that are not accessible to the UV radiation, i.e. inside the bond joint, are not fully reacted. Moreover, UV radiation sources are needed in the carcass assembly line in order to initiate the UV hardening.

WO 96/09352 describes a two-component epoxy structural adhesive wherein the first component comprises an amine hardening agent and a catalyst and the second component contains an epoxide resin having an average epoxy functionality greater than 1. The hardener component here is said to contain calcium salts of nitric acid, of trifluoromethanesulfonic acid, of perchloric acid, of tetrafluoroboric acid or of hexafluoroantimonic acid. In spite of these catalysts this publication proposes curing the two-component adhesive composition by heating to temperatures between 50 and 200° C.

Similarly, EP 705316 B1 proposes two-component epoxide adhesive compositions which as accelerators in the hardener component comprise derivatives of pentafluoroantimonic acid. This publication also proposes heating the bonded structural parts for a short time, by means of induction heating for example, in order to achieve a short handling strength.

Additionally known is accelerating the hardening of two-component epoxide adhesive compositions through addition of short-chain polyfunctional amines such as diethylenetriamine or triethylenetetramine or else tertiary amines such as dimethylethanolamine or dimethylpropanolamine. Also known for acceleration are additions of 2,4,6-trisdimethylaminophenol, isopropylenediphenol, vinylphenol, benzyl alcohol or piperazine derivatives such as aminoethylpiperazine. Additions of this kind to polyamines as a hardener component in epoxide systems adversely affect the mechanical properties of the cured bond; in particular, adhesive compositions of this kind tend toward embrittlement and impairment of the low-temperature impact strength.

In view of this state of the art the inventors set themselves the object of providing two-component epoxide resin adhesive compositions whose mechanical properties match those of the outstanding ultimate properties of the epoxide resin adhesive compositions which can be heat-cured as one-component systems. In this case the bond is to have sufficient handling strength in as short a time as possible after the application of the adhesive and the joining of the structural parts.

### BRIEF SUMMARY OF THE INVENTION

The present invention provides two-component epoxide resin compositions in which the epoxide component A contains at least one epoxide resin with an epoxy functionality greater than 1 and the hardener component B is liquid or pasty and contains amines, polyamides, Mannich bases or compounds containing mercapto groups and additionally contains at least one accelerator selected from the group consisting of dicyandiamide, guanamines, guanidines, aminoguanidines, solid aromatic diamines and mixtures thereof.

The present invention further provides a method for bonding car body structural parts, comprising the following process steps:
a) mixing of the epoxy component (A) with the hardener component (B) in a ratio within the stoichiometrically required amount;
b) subsequently applying this mixture to at least one substrate surface to be bonded;
c) joining the structural parts, followed directly by the partial hardening of the adhesive mixture in the bond joint at room temperature;
d) optionally, further production steps may follow, particularly if the adhesive is used in carcass assembly, cleaning steps of the car body parts may follow, such as phosphating of the metal surface, electrodeposition coating of the metallic surface, in the case of use in final assembly or in the case of vehicle repair these further production processes are omitted; and
e) completely curing the adhesive mixture at room temperature, though in the case of use in carcass assembly the curing may also take place in the oven for electrodeposition coating at temperatures between 130 and 200° C.

Suitable epoxide resins for component A) include a multiplicity of polyepoxides which have at least 2 1,2-epoxy groups per molecule. The epoxide equivalent of these polyepoxides can vary between 150 and 4000. The polyepoxides can in principle be saturated, unsaturated, cyclic or acyclic, aliphatic, alicyclic, aromatic or heterocyclic polyepoxide compounds. Examples of suitable polyepoxides include the polyglycidyl ethers which are prepared by reacting epichlorohydrin or epibromohydrin with a polyphenol in the presence of alkali. Polyphenols suitable for this purpose include, for example, resorcinol, pyrocatechol, hydroquinone, bisphenol A (2,2-bis(4-hydroxyphenyl)propane), bisphenol F (bis(4-hydroxy-phenyl)methane), 1,1-bis(4-hydroxyphenyl)isobutane, 4,4′-dihydroxybenzophenone, 1,1-bis(4-hydroxyphenyl)-ethane, 1,5-hydroxynaphthalene. Likewise suitable are diglycidyl ethers of ethoxylated resorcinol (DGER), e.g., from Indspec.

Further polyepoxides suitable in principle are the polyglycidyl ethers of polyalcohols or diamines. These polyglycidyl ethers are derived from polyalcohols such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Further suitable polyepoxides are polyglycidyl esters of polycarboxylic acids, examples being reaction products of glycidol or epichlorohydrin with aliphatic or aromatic polycarboxylic acids such as oxalic acid, succinic acid, glutaric acid, terephthalic acid or dimer fatty acid.

Further suitable epoxides are derived from the epoxidation products of olefinically unsaturated cycloaliphatic compounds or from natural oils and fats.

Very particular preference is given to the epoxide resins which are derived by reaction of bisphenol A or bisphenol F and epichlorohydrin. In this case it is usual to use mixtures of liquid and solid epoxide resins, the liquid epoxide resins preferably being based on bisphenol A and having a sufficiently low molecular weight. The epoxide resins which are liquid at room temperature generally have an epoxide equivalent weight of from 150 to about 220; particular preference is given to an epoxy equivalent weight range of from 182 to 192.

The epoxy component A) may additionally comprise a further modified epoxide resin which gives the cured bond improved impact strength and low-temperature properties. Modified epoxide resins of this kind are known per se, and comprise reaction products of epoxide resins having an epoxy functionality greater than 1 with carboxyfunctional rubbers, dimer fatty acids or core/shell polymers whose cores have glass transition temperatures of below −30° C. The epoxide resin in this case is employed in a stoichiometric excess and produces an epoxyfunctional reaction product. The excess of epoxide resin may be well beyond the stoichiometric excess. Epoxy functionality greater than 1 for the epoxide resin means in this case that the compounds contain more than 1, preferably at least 2, 1,2-epoxy groups per molecule. For these modified epoxide resins it is preferred to use polyepoxides with an epoxide equivalent of between 150 and 4000. In the same way as with the aforementioned carboxyfunctional modifiers, the modified epoxide resins which can be used can be obtained by reacting low-molecular weight epoxide resins having an epoxy functionality greater than 1 with amino-terminated polyethers, alkyl-, aryl- or alkylarylamines with a functionality of two or more, likewise in a stoichiometric excess.

Examples of modified resins of this kind are the adducts, known per se, of carboxyl-terminated butadiene-acrylonitrile copolymers (CTBN) and liquid epoxide resins based on the diglycidyl ether of bisphenol A. Specific examples are the reaction products of HYCAR CTBN 1300 X8, 1300 X13 or 1300 X15 from Noveon, Inc. with liquid epoxide resins. Additionally it is also possible to employ the reaction products of amino-terminated polyalkylene glycols (Jeffamines) with an excess of liquid polyepoxides. The last-mentioned reaction products are for example disclosed in WO 93/00381. In principle it is also possible to use reaction products of mercaptofunctional prepolymers or liquid sulfur-containing polymers (such as those sold under the trademark THIOKOL) with an excess of polyepoxides as flexibilizing epoxide resins in accordance with the invention. Additionally suitable preferentially are the reaction products of polymeric fatty acids, particularly of dimer fatty acid, with epichlorohydrin, glycidol or, in particular, diglycidyl ether of bisphenol A (DGBA).

Further suitable modifiers for the modified epoxide resins include the core/shell polymers known from U.S. Pat. Nos. 5,290,857 and 5,686,509. In this case the core monomers ought to have a glass transition temperature of less than or equal to −30° C.; these monomers can be selected from the group of the aforementioned diene monomers or suitable acrylate or methacrylate monomers; the core polymer may where appropriate contain crosslinking comonomer units in a small amount. The shell is constructed from a polymer having a glass transition temperature of at least +60° C. The shell polymer is preferably constructed from one or more lower alkyl acrylate or methacrylate monomer units (methyl and/or ethyl esters) and also polar monomers such as (meth)acrylonitrile, (meth)acrylamide, styrene and/or free-radically polymerizable unsaturated carboxylic acids or carboxylic anhydrides.

Further suitable modified epoxide resins for the epoxy components A of the invention are the products of reaction, disclosed in WO 01/94492 pages 10 to 14, of polycarboxylic anhydrides with polyfunctional amino-terminated or hydroxyl-terminated polymers and their subsequent reaction with a large stoichiometric excess of epoxide resins.

In a similar way it is additionally possible to use, as modified epoxide resins, the products of reaction, disclosed in WO 00/20483 on page 8 to 12, of a diamine or polyamine with a carboxylic anhydride and a polyphenol or aminophenol and also their reaction with a stoichiometric excess of a low molecular mass polyepoxide in accordance with the invention.

A further constituent of the epoxy component A may be reactive diluents. Reactive diluents for the purposes of this invention are low-viscosity substances containing epoxide groups (glycidyl ethers or glycidyl esters) with an aliphatic or aromatic structure. These reactive diluents serve on the one hand to lower the viscosity of the binder system above the softening point; on the other hand they are incorporated into the binder system in the course of curing. Typical examples of reactive diluents for use in accordance with the invention are mono-, di- or triglycidyl ethers of C6 to C14 monoalcohols or alkylphenols and also the monoglycidyl ethers of cashew nut shell oil, diglycidyl ethers of ethylene glycol, diethylene glycol, triethylene glycol, tetraethylene glycol, 1,2-propylene glycol, 1,4-butylene glycol, 1,5-pentanediol, 1,6-hexanediol and cyclohexanedimethanol, triglycidyl ethers of trimethylolpropane and also the glycidyl esters of C6 to C24 carboxylic acids or their mixtures.

The hardener component B in accordance with the invention a liquid or pasty component which is intended to initiate the hardening of the two-component epoxide resin adhesive composition of the invention at room temperature. The reactive constituents of the component embrace low-volatility tertiary amines, diamines, polyamines, polyaminoamides, Mannich bases or compounds containing mercaptan groups and also, where appropriate, mixtures of the aforementioned reactive constituents. Additionally suitable are polyetheramines, especially polyoxyethylenediamines, polyoxyethylenetriamines, polyoxypropylenediamines or polyoxypropylenetriamines (also known under the trade name “Jeffamine” from Huntsman) or polyoxytetramethylenediamine as a reactive constituent of the hardener component. Additionally it is possible as a hardener component to use what are called Mannich bases. The Mannich bases suitable for the compositions of the invention are condensation products of diamines or polyamines with active hydrogen components such as aldehydes, ketones, esters or aromatics (e.g. phenols) and/or heteroaromatics. Where appropriate these Mannich bases or else the aforementioned polyamines may include alkyl phenols, as reaction accelerators, in solution. Further suitable reactive constituents of the hardener component include liquid mercaptofunctional prepolymers or liquid polysulfides of the type of the Thiokol polymers. Particularly suitable are polyaminoamides which are prepared in a known way by condensing dimeric or polymeric fatty acids with low molecular weight alkylenediamines or cycloaliphatic diamines.

As accelerators for the hardener component it is possible to use guanidines, substituted guanidines, substituted ureas, melamine resins, guanamine derivatives, cyclic tertiary amines, aromatic amines and/or their mixtures. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, especially, cyanoguanidine (dicyandiamide).

The concentration of the accelerator, especially of the dicyandiamide, in the hardener component may influence the hardening rate of the two-component adhesive of the invention within wide limits without adversely affecting the mechanical properties or the adhesion properties of the adhesive composition.

In one alternative embodiment the accelerator may also be present in the A component provided that it, such as the dicyandiamide, for example, is virtually insoluble in the A component at the storage temperature of the adhesive and becomes soluble only when the B component is mixed in or when the mixture of the components is heated.

Typically the hardener component B contains 0.1% to 10% by weight, preferably between 1% and 5% by weight, of accelerator; with particular preference dicyandiamide is used as an accelerator.

Not only the epoxy component A but also the hardener component B may further comprise fillers and additional auxiliaries and additives.

Examples of suitable fillers include the various ground or precipitated chalks, carbon black, calcium magnesium carbonates, heavy spar and also, in particular, silicatic fillers of the aluminum magnesium calcium silicate type, e.g., wollastonite and chlorite.

The adhesive compositions of the invention may additionally, in both components, contain customary further auxiliaries and additives, such as, for example, plasticizers, rheology auxiliaries—mention may be made by way of example of pyrogenic silicas, bentonites, fibers, precipitated chalks or carbon black—wetting agents, devolatilizers, surfactants, anti-aging agents, stabilizers and/or anticorrosion pigments or color pigments.

The composition of the hardener component B in respect of its reactive constituents is chosen so that simple mixture ratios can be employed; preferably in this context the ratio of the active constituents is chosen so as to enable mixture ratios of A to B of 50:1 to 0.5:1, in particular 1:1, to be chosen. This ratio can be freely chosen on the one hand through the selection of the reactive constituents of the hardener component B that are to be employed, within wide limits; additional formulating freedom is obtained by admixing inert constituents such as plasticizers, fillers or rheology auxiliaries.

Typical ranges for the major constituents of the epoxy component A are as follows:
40% to 80%, preferably 50% to 70%, by weight of one or more liquid and/or solid epoxy resins, with or without a fraction of epoxy functional reactive diluent,
0% to 45%, preferably 5% to 30%, by weight of one or more modified epoxide resins,
5% to 40%, preferably 10% to 30%, by weight of fillers, including where appropriate the rheology auxiliaries and further auxiliaries and additives, the sum of the constituents of component A adding up to 100%.

The hardener component B typically contains the following constituents:
30% to 70%, preferably 40% to 60%, by weight of the amine hardener component, with particular preference a polyaminoamide,
0.5% to 10%, preferably 1% to 5%, by weight of accelerators,
30% to 70%, preferably 40% to 60%, by weight of fillers, including where appropriate the rheology auxiliaries and further auxiliaries and additives, the sum of the constituents of component B adding up to 100%.

The mixing of the liquid and pasty hardener component into the epoxy component takes place advantageously by means of a static or dynamic mixer immediately upstream of the application nozzle of the application system, which may be mounted on an application robot.

The accelerated two-component epoxide resin adhesive compositions of the invention develop after just 1 to 2 hours a sufficient initial strength that the adhesives are resistant to wash-out and reduce warping of structural parts. Additionally it is possible to transport the structural parts without contamination, so that the adhesives can also be used for what are known as externally mounted components which are manufactured alongside the actual carcass assembly production line. Furthermore, these adhesives of the invention can be used in the repair sector, and also in final assembly or in specialty automobile construction, where the typical process heats of the CEC oven for the conventional one-component thermosetting epoxide resin adhesives are not available.

The adhesive compositions of the invention can be varied very easily in their reaction rate through the concentration of the accelerator, without any adverse effect on the mechanical properties of the cured bond. The adhesives contain no ingredients which are a problem from the standpoint of occupational hygiene, since they are neither corrosive nor environmentally hazardous. Strong amine odor, such as is known when using low molecular amines as a hardener component, is avoided. Moreover, the compositions contain no readily volatile constituents, and so the adhesives can be used even for those structural parts which are required to pass through the CEC oven without the formation of blisters as a result of readily volatile constituents.

The examples which follow are intended to illustrate the invention. In the case of the compositions all quantity figures are parts by weight unless indicated otherwise.

### EXAMPLES

In a planetary mixer at room temperature components A and B respectively of the compositions set out below were mixed separately for 15 minutes until homogeneous and then for a further 15 minutes additionally under reduced pressure. Subsequently components A and B were dispensed separately into reservoir vessels.

Component A contains epoxide resins, fillers and a rheology auxiliary; component B contains a polyaminoamide, fillers and a rheology auxiliary.

Formula component A:

| | |
|---|---|
| Standard epoxide resin based on bisphenol A | 60% |
| Modified epoxide resin based on bisphenol A | 15% |
| Inorganic fillers | 22% |
| Rheology auxiliary | 3% |

| Formula component B: | B0 | B1 | B2 | B3 | B4 | B5 |
|---|---|---|---|---|---|---|
| Polyaminoamide | 60% | 60% | 60% | 60% | 60% | 60% |
| Inorganic fillers | 38% | 37% | 36% | 35% | 34% | 33% |
| Dicyandiamide | | 1% | 2% | 3% | 4% | 5% |
| Rheology auxiliary | 2% | 2% | 2% | 2% | 2% | 2% |

For the investigations with different amounts of dicyandiamide (B1 to B5) component B was modified by replacing some of the filler with the corresponding amount of dicyandiamide in accordance with the table above.

Investigation of the Hardening Times:

To determine the hardening times a rheological measurement was carried out at constant temperature. The method used was a plate/plate rotational rheometer from Physica. The shear rate chosen was 0.1 s⁻¹ The hardening time laid down was the exceedance of a viscosity of 100 kPa s.

Component A is mixed with the respective component B in a weight ratio of 1 to 1 and introduced immediately into the measuring system.

| Hardening time at 23° C. | | Hardening time at 60° C. |
|---|---|---|
| B0 | 380 minutes | 38 minutes |
| B1 | 300 minutes | 27 minutes |
| B2 | 260 minutes | 19 minutes |
| B3 | 230 minutes | 15 minutes |
| B4 | 200 minutes | 13 minutes |
| B5 | 190 minutes | 12 minutes |

Influence on Mechanical Properties:

In order to investigate the influence on the mechanical properties, the above-described two-component epoxide structure adhesive was investigated with and without dicyandiamide in the adhesive. The strengths were determined by employing the tensile shear test in accordance with DIN EN 1465. The test specimens used were electroplated steel sheets 0.8 mm thick, such as are customary in the automobile industry. Component A was mixed with the respective component B in a weight ratio of 1:1 and applied to the test specimens. The thickness of the bond was adjusted using 0.3 mm glass beads. Testing was carried out at 23° C.

Testing was carried out on test specimens hardened only at room temperature (RT) and test specimens after 2 hours at RT+30 minutes at 180° C., such as are found, for example, on an automobile line.

| TSS | Hardening 3 days RT | Hardening 30 minutes 180° C. |
|---|---|---|
| B0 | 16.3 MPa | 15.3 MPa |
| B1 | 15.9 MPa | 19.0 MPa |

The fracture pattern for all of the test specimens was cohesive.

1. A two-component epoxide resin composition comprising:
A) an epoxy component containing at least one epoxide resin with an epoxy functionality greater than 1;
B) a liquid or pasty hardener component containing:
a) at least one hardener selected from the group consisting of amines, polyaminoamides, polyetheramines, Mannich bases and compounds containing mercapto groups; and
b) at least one accelerator selected from the group consisting of dicyandiamide, guanamines and derivatives thereof, guanidines, substituted guanidines, aminoguanidines, cyclic tertiary amines, substituted ureas, melamine resins and solid aromatic diamines.

2. The epoxide resin composition as claimed in claim 1, wherein the epoxy component A contains at least one epoxide resin based on diglycidyl ethers of bisphenol A.

3. The epoxide resin composition as claimed in claim 2, wherein the epoxide resin component A contains in addition at least one modified epoxide resin which is a reaction product of at least one epoxide resin with an epoxy functionality greater than 1 with at least one coreactant selected from the group consisting of carboxyfunctional rubbers, dimeric acids, core/shell polymers, amino-terminated polyethers, and difunctional or higher functional amines, the epoxide resin being used in a stoichiometric excess.

4. The epoxide resin composition as claimed in claim 1, wherein the epoxy component A additionally contains an epoxyfunctional reactive diluent.

5. The epoxide resin composition as claimed in claim 1, wherein the hardener component B) additionally contains at least one hardening accelerator selected from the group consisting of substituted ureas, tertiary arylamines, alkylamines, and imidazole derivatives.

6. The epoxide resin composition as claimed in claim 1, wherein at least one of the epoxy component A or the hardener component B contains in addition at least one auxiliary selected from the group consisting of plasticizers, coupling agents, rheology auxiliaries, fillers, wetting agents, anti-aging agents and stabilizers.

7. The epoxide resin composition as claimed in claim 1, wherein the hardener component B contains at least one material selected from the group consisting of aliphatic diamines liquid at room temperature, aromatic diamines liquid at room temperature, polyamines liquid at room temperature, difunctional amino-terminated polyethers, trifunctional amino-terminated polyethers, difunctional polybutadienes, polyfunctional polybutadienes, difunctional polyisoprenes, polyfunctional polyisoprenes, polyaminoamides, Mannich bases, and polymercaptans.

8. The epoxide resin composition as claimed in claim 1, wherein the hardener component B contains dicyandiamide.

9. The epoxide resin composition as claimed in claim 1, wherein the hardener component B contains at least one polyaminoamide.

10. The epoxide resin composition as claimed in claim 1, wherein the hardener component B contains dicyandiamide and at least one polyaminoamide.

11. The epoxide resin composition as claimed in claim 1, wherein the hardener component B contains 30% to 70% by weight hardener(s), 0.5% to 10% by weight accelerator(s), and 30% to 70% by weight filler(s).

12. The epoxide resin composition as claimed in claim 1, wherein the hardener component B contains 30% to 70% by weight of polyaminoamide(s), 0.5% to 10% by weight dicyandiamide, and 30% to 70% by weight filler(s).

13. The epoxide resin composition as claimed in claim 1, wherein the epoxy component A contains 40% to 80% by weight of one or more epoxy resins, 0% to 45% by weight of one or more modified epoxide resins, and 5% to 40% by weight of one or more fillers.

14. The epoxide resin composition as claimed in claim 1, wherein the epoxy component A contains 50% to 70% by weight of one or more epoxy resins, including at least one epoxide resin based on diglycidyl ethers of bisphenol A, 5% to 30% by weight of one or more modified epoxide resins, and 10% to 30% by weight of one or more fillers.

15. A method for bonding car body structural parts using an epoxide resin composition as claimed in claim 1, comprising the following process steps:
a) mixing the epoxy component A with the hardener component B in a ratio within the stoichiometrically required amount to form an adhesive mixture;
b) applying the adhesive mixture to at least one surface of at least one substrate of the car body structural parts to be bonded;
c) joining the structural parts, followed by at least partial hardening of the adhesive mixture at room temperature;
d) optionally executing at least one additional production step selected from the group consisting of cleaning, phosphating, and coating; and
e) optionally accelerating curing of the adhesive mixture by heating the structural parts to 40° C. to 150° C. for 10 to 60 minutes.

16. The method as claimed in claim 15, wherein the mixture ratio of the resin component A and hardener component B as claimed in step a) is 50:1 to 0.5:1.

17. The epoxide resin composition as claimed in claim 1, wherein the epoxy component A contains 50% to 70% by weight of one or more epoxy resins, including at least one epoxide resin based on diglycidyl ethers of bisphenol A, 5% to 30% by weight of one or more modified epoxide resins, and 10% to 30% by weight of one or more fillers and the hardener component B contains 30% to 70% by weight of polyaminoamide(s), 0.5% to 10% by weight dicyandiamide, and 30% to 70% by weight filler(s).
